(19) United States
(12) Patent Application Publication
(10) Pub. No.: US 2024/0351949 A1
(43) Pub. Date: Oct. 24, 2024

(54) CEMENT-CONTAINING COMPOSITION CONTAINING OLIGOMERIC DIALKOXYSILANES

(71) Applicant: Wacker Chemie AG, Munich (DE)

(72) Inventors: Wei Cai, Munich (DE); Dominik JANTKE, Munich (DE); Peter JERSCHOW, Munich (DE); Volker STANJEK, Munich (EP)

(73) Assignee: Wacker Chemie AG, Munich (DE)

(21) Appl. No.: 18/576,754

(22) PCT Filed: Jul. 7, 2021
(86) PCT No.: PCT/EP2021/068846

§ 371 Date: Jan. 5, 2024

(51) Int. Cl. C04B 24/42; C04B 103/00

(52) U.S. Cl. CPC C04B 24/42; C04B 2103/0052

(57) ABSTRACT

A cement-containing composition includes a proportion of 0.05% by weight to 1% by weight, based on the cement content, of an organosilicon compound(S). The organosilicon compound contains at least 70% by weight of units of the formula (1), R¹R² (OR³)ₓSiO_{(2-x)/2} (1). In formula 1, R¹ is a methyl group, R², in all units of the formula (1), may be identical or different and is a monovalent, SiC-bonded, aliphatic hydrocarbon radical having 4 to 22 carbon atoms, R³, in all units of the formula (1), may be identical or different and is a hydrogen atom or an alkyl radical having 1 to 4 carbon atoms, and x is 0 or 1.

The invention relates to a cement-containing composition comprising oligomeric organosilicon compounds and to a method for the bulk hydrophobization of cement-containing compositions, to which the organosilicon compound is added before they have set.

Cement-containing products such as concrete, mortar or cement-based renders are generally considered durable. However, this is true only to a limited extent when such materials are exposed to the weather and frequently come into contact with moisture. Being porous materials, they can absorb water, which is enough on its own to cause visible damage, for example through frost-thaw changes.

In addition, salts can also penetrate into such cement-containing products with the absorbed water, leading to further corrosion damage. For instance, chlorides are critical, especially for reinforced concrete constructions, while alkali metal ions can cause the alkali-silica reaction (ASR), which is notorious for its destructive effect.

A further undesirable consequence of water exclusion in cementitious materials exposed to the weather can be the development of efflorescence. In this phenomenon, which is generally extremely undesirable for visual reasons, salts are dissolved by the water that has penetrated and are brought to the surface by capillary transport, where they remain as a salt residue after the water has evaporated.

One way to protect concrete structures or cementitious plasters is to apply a subsequent coating. This can be done for example through paints, in particular water-repellent silicone resin paints, or by applying a hydrophobizing agent to the surface. Unlike a conventional coating, no protective surface film is formed here; instead, the hydrophobizing agent penetrates the porous material and hydrophobizes the internal surfaces of the pores so that they are no longer able to absorb water via capillary forces. The use of oligomeric dialkyl-functional alkoxy silanes for the hydrophobization of porous mineral substrates is described in EP2927291A1.

However, the drawback of any subsequent surface treatment is the additional work step that is necessary. This is particularly critical in the case of subsequent surface hydrophobization, because the hydrophobizing agent has to penetrate into the previously hydrophilic pores, which is only possible once the substrate in the particular case has dried completely. And even then, a single rain shower can be enough to cause further massive delays.

Moreover, all subsequent surface treatments are effective only at the surface or close to the surface. In the event of damage, drill holes, etc., new possibilities for moisture ingress can be created at any time.

A better option, which in many cases is also much easier to apply, is therefore what is known as bulk hydrophobization, in which a hydrophobizing agent that has a certain water-repellent effect once hardening has taken place is added to the still-liquid cementitious mixture before it has hardened.

It is possible to use for this purpose inter alia fatty acid-based materials, in particular stearates and oleates. However, the achievement of good hydrophobizing properties necessitates the addition of relatively large amounts of these substances, which usually has a significantly adverse effect on the mechanical properties of the hardened material. What is particularly undesirable here is a lowering of the compressive strength of concrete or mortar.

Another class of substances that can be used for the bulk hydrophobization of cementitious mixtures are hydrophobically acting silicon compounds, for example trialkoxysilanes having relatively long alkyl chains, for example iso- or n-octyltriethoxysilanes and/or also alkoxysilyl-functional silicone resins. These can be used either in pure form or as mixtures or else in the form of emulsions. Such cementitious mixtures with silicon-containing hydrophobizing agents are described for example in WO2011/128127A and EP2202210A.

However, the use of these materials usually results in a significant loss of flexural and compressive strength in the hardened concrete or mortar.

The object of the invention was therefore to provide a cementitious mixture that has improved water repellency but no longer has the disadvantage of reduced compressive strength.

The invention provides a cement-containing composition comprising a proportion of 0.05% by weight to 1% by weight, based on the cement content, of an organosilicon compound(S) consisting of at least 70% by weight of units of the formula (1)

R¹R²(OR³)ₓSiO_{(2-x)/2} (1),
where
R¹ is a methyl group,
R² in all units of the formula (1) may be identical or different and is a monovalent, SiC-bonded, aliphatic hydrocarbon radical having 4 to 22 carbon atoms,
R³ in all units of the formula (1) may be identical or different and is a hydrogen atom or an alkyl radical having 1 to 4 carbon atoms, and
X is 0 or 1.

Preferably, the radicals R² are alkyl radicals having 8 to 16, especially 8, 10, 12, 14 or 16, carbon atoms. The radicals R² may be branched or unbranched. More preferably, the radicals R² are an n-octyl radical or a 2,4,4pentyl radical attached to the silicon atom by atom C1. This radical is in the text that follows also referred to as the isooctyl radical.

Preferably, x has the value 0 in at least 50% of all units of the formula (1), averaged over all molecules of the organosilicon compounds(S).

Preferably, the organosilicon compounds(S) consist to an extent of at least 90% of units of the formula (1), more preferably they consist exclusively of units of the formula (1).

Especially preferably, the organosilicon compounds(S), which are mixtures of linear compounds of the formulas (1a) and cyclic compounds of the formula (1b),

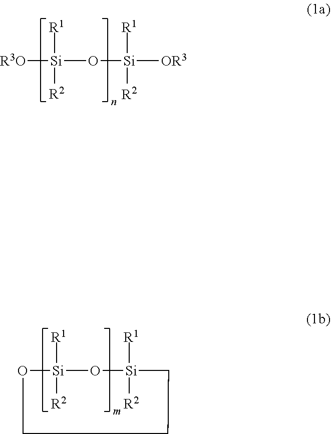

where
n has a value from 0 to 100, preferably 1 to 10 and
m has a value from 3 to 100, preferably 2 to 10,
and all other variables are as defined in formula (1).

The radical R² is preferably a branched or unbranched monovalent, SiC-bonded, aliphatic hydrocarbon radical having 6 to 16 carbon atoms, more preferably a branched or unbranched monovalent, SiC-bonded, aliphatic hydrocarbon radical having 8 to 12 carbon atoms, especially preferably an n-octyl radical or a 2,4,4-trimethylpentyl radical, which is also referred to as isooctyl radical.

R³ is preferably hydrogen or a branched or unbranched monovalent, SiC-bonded, aliphatic hydrocarbon radical and hydrogen atom having 1 to 3 carbon atoms, more preferably hydrogen or a methyl or ethyl radical.

The invention is based on the surprising discovery that the organosilicon compounds(S) of the invention not only have a good hydrophobizing effect in the hardened cementitious mixture, but also do not lead to a significant loss of flexural strength and compressive strength. In mortars and—more importantly still—in concrete, this represents a key advantage.

Therefore, a mortar or concrete characterized in that it has a proportion of 0.05% by weight to 0.5% by weight, based on the cement content, of organosilicon compounds(S) consisting of at least 70% by weight of units of the formula (1) represents a preferred subject matter of the invention.

A corresponding concrete represents a particularly preferred subject matter of the invention.

The invention further provides a method for the bulk hydrophobization of cement-containing compositions, in which a proportion of 0.05% by weight to 1% by weight, preferably 0.05% by weight to 0.5% by weight, based on the cement content, of organosilicon compounds(S) is added to the cement-containing compositions before they have set. This preferably achieves a reduction in water absorption of at least 30%, more preferably of at least 40%, especially preferably of at least 50%, in each case based on an identical cement-containing composition without the organosilicon compounds(S).

Preferably, the use of the organosilicon compounds(S) results in a lowering of the compressive strength of the hardened cement-containing composition of the invention of less than 5%, more preferably of less than 2%, in each case based on an identical cement-containing composition without the organosilicon compounds(S). In an especially preferred embodiment of the invention, the flexural and compressive strength of the hardened cement-containing composition of the invention is not lowered at all or is even improved compared to an identical cement-containing composition without the organosilicon compounds(S).

Preferably, the use according to the invention of the organosilicon compounds(S) results in a lowering of the flexural strength of the hardened cement-containing composition of the invention of less than 5%, more preferably of less than 2%, in each case based on an identical cement-containing composition without the organosilicon compounds(S). In an especially preferred embodiment of the invention, the flexural strength of the hardened cement-containing composition of the invention is not lowered at all or is even improved compared to an identical cement-containing composition without the organosilicon compounds(S).

Preferably, the use according to the invention of the organosilicon compounds(S) results both in a reduction in water absorption of at least 30%, more preferably of at least 40%, especially preferably of at least 50%, in each case, based on an identical cement-containing composition without the organosilicon compounds(S), and in a lowering of the compressive strength of the hardened cement-containing composition of the invention of less than 5%, more preferably of less than 2%, and especially preferably even in an identical or even improved compressive strength in the hardened cement-containing composition of the invention, in each case based on an identical cement-containing composition without the organosilicon compounds(S).

In addition to the advantages mentioned above, the method according to the invention also has the further advantage that the organosilicon compounds(S) can be added to the clinker before grinding. It is also in principle possible to add the organosilicon compounds(S) during or after the grinding process. The addition can take place before, during or after the addition of gypsum and—if used—other additives, such as lime, blast furnace slag, fly ash or pozzolans. The organosilicon compounds(S) can also be used for the production of mixed cements. For this purpose, individual cements, each produced separately by grinding with the organosilicon compounds(S), can be mixed or a mixture of a plurality of cement clinkers can be ground with the organosilicon compounds(S) to obtain a mixed cement. These organosilicon compounds(S) can be employed separately from other grinding auxiliaries during grinding. The organosilicon compounds(S) are preferably metered into the clinker such that the organosilicon compounds(S) are present in amounts of 0.05% by weight to 1.0, preferably 0.05-1.0% by weight, more preferably between 0.1% and 0.5% by weight, based on the clinker to be ground. The grinding process usually takes place in a cement mill, for example in a ball mill or vertical mill. However, it is also in principle possible to use other mills such as are known in the cement industry. It has been established that the organosilicon compounds(S) are suitable as cement grinding auxiliaries.

The cement used in the cementitious composition of the invention is preferably cement of type CEM I, II, III, IV or V (according to standard EN 197-1), or cement of type I, IA, II, IIA, III, IIIA, IV or V (according to ASTM C150/C150M), or cement of type IS, IP, IL or IT (according to ASTM C595/C595M), or alumina cement (according to EN 14647), or cement of type URH, VRH, MRH, GRH (according to ASTM C1600/C1600M), or deep drilling cement of type A, B, C, D, G, H, O, K or L (according to API Spec 10A standard), or magnesia binder cement (Sorel cement). Also suitable are all cements produced according to a different standard, for example according to the Chinese GB standard or Indian IS standard. Where reference is made here to cement grades according to EN, ASTM or API standards, this of course relates to corresponding cement compositions produced according to a different cement standard too.

However, it may also be advantageous when the binder composition additionally comprises other binders. These are in particular latent hydraulic binders and/or pozzolanic binders.

Examples of suitable latent hydraulic and/or pozzolanic binders are slag, fly ash and/or silica fume, etc. The binder composition may also include inert substances such as limestone powder, quartz powder and/or pigments, etc. These substances may also be added/employed as additives during mixing of the mineral binder composition, again in a conventional manner.

Customary aggregates include natural aggregates, industrially produced aggregates, or recycled aggregates, for example natural sand, manufactured sand, gravel, gravel sand, and chippings.

Mineral building material compositions may in addition comprise customary additives that influence the properties of the building material composition. Plasticizers such as lignosulfonates, sulfonated naphthalene-formaldehyde condensates, sulfonated melamine-formaldehyde condensates and/or polycarboxylate ethers (PCE) may be used as additives. Examples of possible further additives include flow improvers, retarders, accelerators, air-entraining agents, grouting aids, stabilizers, viscosity modifiers, shrinkage reducers, defoamers and/or foaming agents, recycling aids, and pigments.

In the examples described below, all viscosity data relate to a temperature of 25° C. Unless otherwise stated, the examples that follow are carried out at the pressure of the ambient atmosphere, i.e. at about 1000 hPa, and at room temperature, i.e. at about 23° C., or at a temperature that results when combining the reactants at room temperature without supplemental heating or cooling, and at a relative humidity of about 50%. In addition, all reported parts and percentages are unless otherwise stated based on weight.

### EXAMPLE 1: PREPARATION OF OLIGOMERIC OCTYLMETHYLDIMETHOXSILANE

A 1000 ml three-necked flask equipped with a heating means, stirrer, dropping funnel, and reflux condenser is initially charged with 474 g (2.17 mol) of octylmethyldimethoxsilane (commercially available from ABCR, Karlsruhe, Germany) and heated to 80° C. At this temperature, 1.98 g of 25% aqueous HCl is added from the dropping funnel at a constant rate over a period of 10 min with intensive stirring, this being accompanied by the initial development of turbidity (two-phase system) in the reaction mixture. The reaction mixture is stirred at 80° C. for a further 30 min, becoming clear again a few minutes after the end of the addition.

46.9 g of water is then added at the same temperature over a period of 95 min. A discernible exothermic reaction develops, causing the reaction temperature to rise to ˜83° C. The reaction mixture remains clear during the metered addition of the first 20 g, after which it becomes turbid (two-phase system).

Low boilers (HCl-acidic ethanol) are then first distilled off at ambient pressure (˜1013 mbar), this being accompanied by a rise in the bottoms temperature to 110° C. As soon as no more distillate is being produced, the pressure is gradually reduced to approx. 10 mbar and the distillation continued until there is again no more distillate being produced. A total of about 135 g of distillate is obtained. The residue in the flask is single-phase and clear.

The residue in the flask is heated again to 80° C. and treated with 0.2 g of 25% aqueous HCl, as a result of which the reaction mixture again initially becomes slightly turbid and then clears again when stirred for 30 min at 80° C. after the addition.

Then, at the same temperature, 4.7 g of water is added over a period of 5 min and the mixture is stirred for a further 2 h. The reaction mixture remains clear during this time.

Finally, low boilers are first distilled off at ambient pressure (˜1013 mbar), this being accompanied by a rise in the bottoms temperature to 110° C. As soon as no more distillate is being produced, the pressure is gradually reduced to approx. 4 mbar and the distillation continued until there is again no more distillate being produced. A total of about 7 g of distillate is obtained.

The obtained product is single-phase and clear. It has a viscosity at 23° C. of 19.8 m·Pas. 1H-NMR shows it to consist of approx. 40% of cyclic oligosilane compounds and approx. 60% of linear oligosilane compounds. The proportion of Si—OH chain ends is 0.07% by weight and the proportion of Si—OCH₃ chain ends is approx. 0.8% by weight (calculated as Si_{1/2}OH and Si_{1/2}OCH₃ respectively). The total chlorine content in the product is below 0.05% by weight.

### EXAMPLE 2: PRODUCTION OF TEST SPECIMENS

The test specimens are produced on a planetary mixer from Toni-Technik according to the following scheme:
slow mixing of cement and sand (30 sec)
addition of water while mixing slowly (30 sec)
addition of additive while mixing slowly (30 sec)
intensive mixing (30 sec)
pause (90 sec)
intensive mixing (60 sec)

The extent of spread of the mortar mixtures produced is 17.25±0.25 cm.

The composition of the mortar mixtures is shown in Table 1.

TABLE 1
Composition of the test specimens

| | Cement | | | | |
|---|---|---|---|---|---|
| | CEM I | | | | Additive |
| Example | 42.5 R | Sand* | Water | Additive | content** |
| 2-1*** | 900 g | 2700 g | 425 g | — | — |
| 2-2 | 900 g | 2700 g | 425 g | 1.8 g of siloxane | 0.2% by |
| | | | | from example 1 | weight |
| 2-3 | 900 g | 2700 g | 425 g | 4.5 g of siloxane | 0.5% by |
| | | | | from example 1 | weight |
| 2-4*** | 900 | 2700 | 425 | 4.5 g of monomeric | 0.5% by |
| | | | | octyltriethoxysilane | weight |
| 2-5 | 900 | 2700 | 425 | 4.5 g of oligomeric | 0.5% by |
| | | | | octyltriethysilane | weight |
| | | | | having a viscosity | |
| | | | | of ~60 mPa · s | |

*standard sand according to DIN EN 196-1
**based on the amount of cement added.
***noninventive

Six test samples having dimensions of 160 mm×40 mm×40 mm were produced from each mortar mixture.

### EXAMPLE 3: DETERMINATION OF CAPILLARY WATER ABSORPTION IN ACCORDANCE WITH DIN EN 1015-18

The test specimens are produced in accordance with DIN EN 1015-11, stored at 23° C. and 50% humidity, and after 27 days the long sides of the test specimens are sealed with a sealant. This is followed after 28 days by storage in water, by placing the test specimens in a dish with the unsealed side facing down in an immersion depth of 10 mm.

The results are shown in Table 2.

### EXAMPLE 4: DETERMINATION OF COMPRESSIVE STRENGTH IN ACCORDANCE WITH DIN EN 1015-11

This test is performed using the fragments of the test specimens from the measurement of flexural strength. The test specimen is inserted into the testing machine such that one molded side of the specimen is in contact with each of the load surfaces of the testing machine. The load is applied in an impact-free manner and increased steadily until break occurs. From the maximum load (in N) is calculated the compressive strength (in N/mm2).

The results are shown in Table 2.

TABLE 2
Results of the tests according to examples 3
and 4 on the test specimens from example 2.

| | | Capillary | Reduction | |
|---|---|---|---|---|
| Produced | | water | in water | Compressive |
| according | Dosing | absorption | absorption | strength |
| to example | additive | [g/m2] | [%] | [N/mm2] |
| 2-1* | — | 1773 | — | 47.0 |
| 2-2 | 0.2% by | 671 | 62 | 47.4 |
| | weight | | | |
| 2-3 | 0.5% by | 352 | 80 | 48.4 |
| | weight | | | |
| 2-4* | 0.5% by | 281 | 84 | 39.1 |
| | weight | | | |
| 2-5 | 0.5% by | 554 | 68 | 41.1 |
| | weight | | | |

*noninventive

1-6. (canceled)

7. A cement-containing composition comprising a proportion of 0.05% by weight to 1% by weight, based on the cement content, of an organosilicon compound(S) consisting of at least 70% by weight of units of the formula (1)
R¹R²(OR³)ₓSiO_{(2-x)/2} (1),
where
R¹ is a methyl group,
R² in all units of the formula (1) may be identical or different and is a monovalent, SiC-bonded, aliphatic hydrocarbon radical having 4 to 22 carbon atoms,
R³ in all units of the formula (1) may be identical or different and is a hydrogen atom or an alkyl radical having 1 to 4 carbon atoms, and
x is 0 or 1.

8. The composition as claimed in claim 7, in which R² is an alkyl radical having 8 to 16 carbon atoms.

9. The composition as claimed in claim 7, in which the organosilicon compounds(S) are mixtures of linear compounds of the formula (1a) and cyclic compounds of the formula (1b), 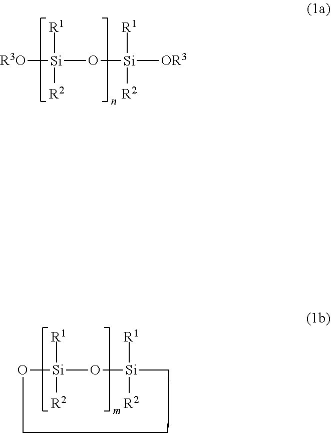
where
n has a value from 1 to 100 and
m has a value from 3 to 100,
and R¹ and R² are as defined in claim 1.

10. The composition as claimed in claim 7, in which R³ is hydrogen or a methyl or ethyl radical.

11. The composition as claimed in claim 7, which is a mortar or concrete.

12. A method for the bulk hydrophobization of cement-containing compositions in which added to the cement-containing compositions, before they have set, is a proportion of 0.05% by weight to 1% by weight, based on the cement content, of organosilicon compound(S) consisting of at least 70% by weight of units of the formula (1)
R¹R²(OR³)ₓSiO_{(2-x)/2} (1),
where
R¹ is a methyl group,
R² in all units of the formula (1) may be identical or different and is a monovalent, SiC-bonded, aliphatic hydrocarbon radical having 4 to 22 carbon atoms,
R³ in all units of the formula (1) may be identical or different and is a hydrogen atom or an alkyl radical having 1 to 4 carbon atoms, and
x is 0 or 1.
